(19) United States
(12) Patent Application Publication
(10) Pub. No.: US 2026/0052007 A1
(43) Pub. Date: Feb. 19, 2026

(54) METHOD OF DATA PROCESSING FOR SECURE COMPUTATION, STORAGE MEDIUM AND ELECTRONIC DEVICE

(71) Applicant: Beijing Volcano Engine Technology Co., Ltd., Beijing (CN)

(72) Inventors: Qizhi Zhang, Beijing (CN); Yu Lin, Beijing (CN); Quanwei Cai, Beijing (CN); Jue Hong, Beijing (CN); Ye Wu, Beijing (CN)

(21) Appl. No.: 19/256,003

(22) Filed: Jun. 30, 2025

(30) Foreign Application Priority Data
Aug. 16, 2024 (CN) 202411132997.6

(51) Int. Cl. H04L 9/06; H04L 9/00

(52) U.S. Cl. CPC H04L 9/0662; H04L 9/008; H04L 9/0618

(57) ABSTRACT

A method of data processing for secure computation, a storage medium, and an electronic device are provided. The method includes: performing a data processing process based on a target protocol with the second party based on the first identification set, so that the second party obtains at least a first index number of an intersection of the first identification set and the second identification set in the first identification set; obtaining a first polynomial corresponding to each individual dimension of at least some dimensions in the h-dimensional features; computing values of the first polynomial on at least part of identifications in a target identification set with the second party to obtain a first shard of the values; and performing a target data processing task based at least on the first shard.

### CROSS-REFERENCE TO RELATED APPLICATION

The present disclosure claims priority of the Chinese Patent Application No. 202411132997.6 filed on Aug. 16, 2024, the disclosure of which is incorporated herein by reference in its entirety as part of the present application.

### TECHNICAL FIELD

The present disclosure relates to a method of data processing for secure computation, a storage medium, and an electronic device.

### BACKGROUND

Secure multi-party computation, also referred to as multi-party secure computation (Multi-Party Computation, MPC), may be used for a plurality of parties to jointly compute a result of a function without divulging input data of respective parties in the function, and the computed result is disclosed to one or more of the parties. Typical applications of secure multi-party computation include, for example, joint statistical analysis of multi-party data with privacy protection, machine learning, and the like. The function here is a function for statistical computation, a machine learning algorithm, and the like.

In a process of multi-party secure computation, in order not to divulge data of respective parties and intermediate computation results, the data or the intermediate results may be held by the parties in a shared form. One party holds one data shard, and shards held by the parties are fused together to restore corresponding data. In the development and application promotion of MPC technologies, in addition to the security of the MPC computation protocol itself, the accuracy of the MPC itself also needs to be emphasized. How to guarantee the accuracy of the MPC is crucial for guaranteeing the reliability and effectiveness of the process and results of the multi-party secure computation.

### SUMMARY

The Summary is provided to introduce concepts in a brief form, which will be described in detail in the Detailed Description section below. The Summary is not intended to identify key features or essential features of the claimed technical solutions, nor is it intended to be used to limit the scope of the claimed technical solutions.

The present disclosure provides a method of data processing for secure computation, where parties involved in the secure computation include a first party and a second party, the first party holds a first identification set, and an identification in the first identification set corresponds to h-dimensional features, the second party holds a second identification set, where h≥1, and the method is applied to the first party and includes:
performing, based on the first identification set, a data processing process based on a target protocol with the second party, such that the second party obtains at least a first index number of an intersection of the first identification set and the second identification set in the first identification set;
obtaining, for each individual dimension of at least some dimensions of the h-dimensional features, a first polynomial corresponding to the individual feature, where the first polynomial is constructed based on the individual dimension corresponding to an identification in a third identification set, and the third identification set is generated based on index numbers of identifications in the first identification set; and computing, with the second party, values of the first polynomial on at least part of identifications in a target identification set to obtain a first shard of the values, where the target identification set is generated by the second party based on the first index number, and the third identification set and the target identification set are generated in a same manner; and
performing a target data processing task based at least on the first shard.

The present disclosure provides a method of data processing for secure computation, where parties involved in the secure computation include a first party and a second party, the first party holds a first identification set, and an identification in the first identification set corresponds to h-dimensional features, the second party holds a second identification set, where h≥1, and the method is applied to the second party and includes:
performing, based on the second identification set, a data processing process based on a target protocol with the first party to obtain at least a first index number of an intersection of the first identification set and the second identification set in the first identification set;
generating a target identification set based on the first index number;
computing, for each of at least one first polynomial, values of the first polynomial on at least part of identifications in the target identification set with the first party to obtain a sixth shard of the values, where the at least one first polynomial is constructed by the first party for each individual dimension of at least some dimensions in the h-dimensional features based on the individual dimension corresponding to an identification in a third identification set, the third identification set is generated by the first party based on index numbers of identifications in the first identification set, and the third identification set and the target identification set are generated in a same manner; and
performing a target data processing task based at least on the sixth shard.

The present disclosure provides a computer-readable medium having a computer program stored thereon, where the program, when executed by a processing apparatus, implements the steps of the method of data processing for secure computation provided in the embodiments of the present disclosure.

The present disclosure provides an electronic device, including:
a storage apparatus having a computer program stored thereon; and
a processing apparatus, configured to execute the computer program in the storage apparatus to implement the steps of the method of data processing for secure computation provided in the embodiments of the present disclosure.

The present disclosure provides a computer program product, including a computer program, where the program, when executed by a processor, implements the steps of the method of data processing for secure computation provided in the embodiments of the present disclosure.

### BRIEF DESCRIPTION OF DRAWINGS

The preceding and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that parts and elements are not necessarily drawn to scale. In the drawings:

FIG. 1 is a flowchart of a method of data processing for secure computation applied to a first party according to an exemplary embodiment;

FIG. 2 is a schematic diagram of a first party and a second party executing an oblivious pseudo-random function protocol according to an exemplary embodiment;

FIG. 3 is a schematic diagram of a first party and a second party executing an oblivious pseudo-random function protocol according to another exemplary embodiment;

FIG. 4 is a flowchart of a method of data processing for secure computation applied to a second party according to an exemplary embodiment;

FIG. 5 is a block diagram of an apparatus of data processing for secure computation applied to a first party according to an exemplary embodiment;

FIG. 6 is a block diagram of an apparatus of data processing for secure computation applied to a second party according to an exemplary embodiment; and

FIG. 7 is a schematic structural diagram of an electronic device according to an exemplary embodiment.

### DETAILED DESCRIPTION

Before introducing specific embodiments of the present disclosure, nouns involved in the present disclosure and specific application scenarios of multi-party secure computation are first introduced and described.

Ring: refers to a set, which defines two operations, addition and multiplication, and forms a commutative group (an abelian group) for addition, a semigroup for multiplication of elements other than 0, and the multiplication satisfies the distribution rate for addition.

Secret sharing, also referred to as secret splitting or secret sharing, has a basic principle of splitting a secret (such as a key, privacy data, etc.) into a plurality of shares, which are separately stored by different data parties. Only when parties exceeding the threshold count combine their shards, the secret can be restored; and the share obtained from the plurality of parties less than the threshold count cannot restore any information of the secret. In multi-party secure computation, the threshold count is usually the same as the count of parties involved, and the shares into which the secret is split may also be referred to as shards. The privacy data is data that other parties are not expected to know in the multi-party secure computation.

Private set intersection (PSI) is a type of proprietary protocol in the field of secure multi-party computation, which allows two participating parties to input private sets to jointly compute a set intersection, and ensures that no additional element information other than the result of the set intersection is divulged.

Homomorphic encryption is a technique that allows computation on encrypted data (i.e., ciphertext) and then decryption to obtain a result, and the computation result of the homomorphic encryption is the same as the result of direct computation of the original data (i.e., plaintext), but the entire computation process is performed on the encrypted data.

Offline: a process of data processing performed in advance before a real computation task is executed, and generally, the time requirement of an offline process is not strict.

Online: a process of executing a real computation task, and it is usually desired that an online computation can be completed as soon as possible.

Communication volume: since data of parties involved in secure computation is on different machines, interaction needs to be completed through network communication, and ciphertext data will be transmitted on the network during the computation process, and the amount of data transmitted is the communication volume.

In practical applications, for the purpose of privacy protection, multi-party secure computation algorithms are usually black-box algorithms, and data transmission behaviors between respective computing nodes loaded with the multi-party secure computation algorithms are opaque. As discussed in the Background section, typical applications of multi-party secure computation include machine learning, where the multi-party secure computation technology can be used to protect privacy data in the inference and training stages of machine learning, mainly involving protection of model parameters and protection of data of each party involved in the training process.

At present, common privacy protection machine learning solution strategies based on secure multi-party computation include: privacy protection machine learning protocols based on technologies such as garbled circuit and oblivious transfer, and executing a secure multi-party computation protocol to complete computation of non-linear operations such as activation functions. Technologies based on secret sharing allow multiple parties to participate in training or prediction of a machine learning network model, and the process does not reveal data or model information.

In addition to the preceding application fields, the multi-party secure computation can also be applied to fields such as network security detection with privacy protection, joint statistical analysis of multi-party data with privacy protection, spam cleaning and filtering of encrypted emails, advertisement conversion, and the like.

The two-party secure computation is usually used for joint statistical analysis of two-party data with privacy protection, that is, querying across two-party databases while protecting private data of the two parties.

For example, consider the following Structured Query Language (SQL) statement:
select avg(a.key) from a join b on a.id=b.id;

The SQL statement is used to align the table a with the table b according to an id column, and then perform an averaging operation on a.key based on the aligned tables to obtain a query result. The table a is stored in a first party P0, the table a includes an id column and at least one feature column, the table b is stored in a second party P1, the table b includes an id column, and the P0 party and the P1 party perform an SQL query through a two-party secure computation technology without exposing their own privacy data to each other, and only expose the query result to a querying party after the query is completed, and the query result is stored in the P0 party and the P1 party in a form of shards.

Specifically, in the related art, the P0 party and the P1 party align the table a with the table b according to the id column (which may be referred to as PSI to share) in the following manner, so as to store the feature held by the P0 party and corresponding to the intersection in the P0 party and the P1 party in the form of shards, where the intersection is an intersection of a first identification set (consisting of all elements in the id column of the table b) held by the P1 party and a second identification set (consisting of all elements in the id column of the table a) held by the P0 party: the P0 party constructs a polynomial based on each feature column held by itself; then, the P0 party and the P1 party securely compute values of the polynomial on the first identification set, and both parties obtain one shard of the values respectively, as the feature shard corresponding to the preceding intersection, that is, the feature held by the P0 party and corresponding to the preceding intersection is stored in the P0 party and the P1 party in the form of shards, so that both parties can perform the SQL query based on the feature shards held by themselves respectively.

In the case where the first identification set is a subset of the second identification set, the preceding intersection is the first identification set, and at this time, the feature shard obtained by the preceding related art is an accurate result of the feature shard corresponding to the intersection of the first identification set and the second identification set; in the case where the first identification set is not a subset of the second identification set, the feature shard obtained by the preceding related art is a superset of the feature shard corresponding to the preceding intersection. Therefore, the preceding related art cannot guarantee the accuracy of the feature shard in all cases.

In view of this, the present disclosure provides a method of data processing for secure computation, a medium, a device, and a product to ensure the accuracy of the feature shard.

The embodiments of the present disclosure will be described in more detail below with reference to the drawings. Although some embodiments of the present disclosure are shown in the drawings, it should be understood that the present disclosure may be implemented in various forms, and should not be construed as limited to the embodiments set forth herein, rather, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that respective steps described in the method implementations of the present disclosure may be performed in different orders and/or in parallel. In addition, the method implementations may include additional steps and/or omit to perform the illustrated steps. The scope of the present disclosure is not limited in this respect.

The term “include/comprise” and variations thereof as used herein are open-ended inclusions, that is, “include/comprise but not limited to”. The term “based on” is “based at least in part on”. The term “one embodiment” represents “at least one embodiment”; the term “another embodiment” represents “at least one additional embodiment”; and the term “some embodiments” represents “at least some embodiments”. Related definitions of other terms will be given in the following description.

It should be noted that concepts such as “first” and “second” mentioned in the present disclosure are only used to distinguish between different apparatuses, modules or units, and are not used to limit the order or interdependence of functions performed by these apparatuses, modules or units.

It should be noted that modifications of “one” and “a plurality of” mentioned in the present disclosure are illustrative and not restrictive, and those skilled in the art should understand that unless the context clearly indicates otherwise, they should be understood as “one or more”.

The names of messages or information exchanged between a plurality of apparatuses in the implementations of the present disclosure are only for illustrative purposes, and are not intended to limit the scope of these messages or information.

It can be understood that before using the technical solutions disclosed in the embodiments of the present disclosure, users should be informed and granted authorization in an appropriate manner in accordance with relevant laws and regulations for the types, usage scope, usage scenarios, etc. of personal information involved in the present disclosure.

For example, when receiving an active request from a user, prompt information is sent to the user to explicitly prompt the user that the operation requested to be performed will require acquisition and use of the user's information. Thereby, the user can independently select whether to provide information to software or hardware such as an electronic device, an application, a server, or a storage medium that performs the operation of the technical solution of the present disclosure according to the prompt information.

As an optional but non-limiting implementation, the manner of sending the prompt information to the user in response to receiving the active request from the user may be, for example, a pop-up window, and the prompt information may be presented in text in the pop-up window. In addition, the pop-up window may also carry a selection control for the user to select “agree” or “disagree” to provide information to the electronic device.

It can be understood that the preceding process of notifying and acquiring user authorization is only illustrative, and does not constitute a limitation to implementations of the present disclosure, and other manners that meet relevant laws and regulations may also be applied to implementations of the present disclosure.

At the same time, it can be understood that data involved in the technical solution (including but not limited to the data itself, acquisition or use of the data) should conform to requirements of corresponding laws, regulations, and related provisions.

Before describing the specific implementations of the present disclosure, the core idea of the method of data processing for secure computation in the present disclosure is first introduced.

In the present disclosure, parties involved in the secure computation include a first party and a second party, where the first party holds a first identification set, and an identification in the first identification set corresponds to h-dimensional features, that is, each identification in the first identification set corresponds to h-dimensional features respectively, the second party holds a second identification set, where h≥1, that is, each identification in the first identification set corresponds to at least one individual dimension respectively. Both the first identification set and the second identification set include at least one identification, and the first identification set is different from the second identification set. Exemplarily, the first party is the preceding P0, and the second party is the preceding P1.

In one implementation, an identification in the preceding second identification set may correspond to a single-dimensional feature, and each identification in the second identification set corresponds to a single-dimensional feature respectively, that is, both the first party and the second party hold features, and at this time, the preceding h-dimensional features do not include the single-dimensional feature.

Exemplarily, for the preceding SQL statement, the table b also includes one feature column in addition to the id column, and the feature column and the at least one feature column in the table a belong to features of different dimensions.

In another implementation, the identification in the preceding second identification set may not correspond to any feature, that is, only the first party holds the feature.

The core idea of the method of data processing for secure computation is to convert the problem of sharding the feature corresponding to the intersection of the first identification set and the second identification set into the problem of polynomial evaluation. Specifically, the first party may encode each individual dimension of the at least some dimensions in the h-dimensional features into one polynomial, such that the value of the polynomial on the corresponding identification in the third identification set is the value of the individual dimension corresponding to the identification; then, values of the respective polynomials encoded by the first party on the identifications in the target identification set are computed, where the values are distributed in the first party and the second party in the form of shards, and the value shards are the feature shards corresponding to the corresponding identifications in the target identification set. The third identification set is generated based on index numbers of the identifications in the first identification set, the target identification set is generated by the second party based on the first index number of the intersection in the first identification set, and the third identification set and the target identification set are generated in the same manner. The preceding first index number of the intersection in the first identification set is synchronized by the first party to the second party, and the first index number is used to characterize the index position of the element in the preceding intersection that belongs to the first identification set. The “index number” here may be understood as the position identification of the element in the intersection in the corresponding set, for example, a row number, which has no actual physical meaning.

The degree of each polynomial encoded by the first party is the count of identifications in the third identification set (that is, the count of identifications in the first identification set), and the communication volume in polynomial evaluation is proportional to the degree of the polynomial. Thus, when the count of identifications in the third identification set is large, it indicates that the degree of the polynomial is high, and direct evaluation of it will result in huge communication overhead. Therefore, the polynomial evaluation process may be considered to be split into two sub-processes, that is, degree reduction (that is, reducing the degree of the polynomial) and evaluation, which are performed in sequence.

In the degree reduction sub-process, the degree of the polynomial is reduced from the O(N) level to the O(q) level, and in the evaluation sub-process, the O(q)-degree polynomial is respectively evaluated on each of the q identifications in the target identification set, where N is the count of identifications in the first identification set, and q is the count of identifications in the target identification set. The degree of the polynomial can be reduced based on the following theorem:

Theorem: let [symbol] be a field,

$$g ( x ) = {\prod }_{w = 0}^{q - 1} ( x - {x}_{w} ) ∈ 𝔽 [ x ] ,$$

x_{w} be the w-th identification in the target identification set, [symbol] [x] be a group of polynomials with coefficients in x, and x be an independent variable, if \tilde{f}(x)=f(x) mod g(x), then \tilde{f}(xᵢ)=f(xᵢ), w=0 . . . , q−1, and \tilde{f}(x) and f(x) are both polynomials in [symbol] [x], that is, if one polynomial is equal to another polynomial mod g(x), then the values of the two polynomials on the same identification are equal.

Specifically, firstly, the first arty converts the polynomial f(x) into the following form:

$$f ( x ) = {\sum }_{k = 0}^{⌊ N / q ⌋} {f}_{k} ( x ) {x}^{kq}$$

where fₖ(x) is the k-th polynomial, and its degree is less than or equal to q−1.

Then, the second party prepares data hₖ(x)=x^{kq}modg(x), k=0, 1, 2, . . . , L, L=└N/q┘, and then:

$$f ( x ) mod g ( x ) = {\sum }_{k = 0}^{⌊ N / q ⌋} {f}_{k} ( x ) {x}^{kq} mod g ( x ) = {\sum }_{k = 0}^{⌊ N / q ⌋} {f}_{k} ( x ) {h}_{k} ( x ) = \tilde{f} ( x )$$

that is, the polynomials

$$\tilde{f} ( x ) = {\sum }_{k = 0}^{⌊ N / q ⌋} {f}_{k} ( x ) {h}_{k} ( x )$$

and the degrees of \tilde{f}(x) are less than or equal to 2q−2, and \tilde{f}(x) is the polynomial obtained after the degree reduction process is performed on the polynomial f(x).

Exemplarily, N=7, q=3, f(x)=a₀+a₁x+a₂x²+a₃x³+a₄x⁴+aₛx⁵+a₆x⁶+a₇x⁷, then └N/q┘=2, and at this time, f(x) may be converted into the following form:

$$f ( x ) = ( {a}_{0} + {a}_{1} x + {a}_{2} {x}^{2} ) + ( {a}_{3} + {a}_{4} x + {a}_{5} {x}^{2} ) {x}^{3} + ( {a}_{6} + {a}_{7} x + {a}_{8} {x}^{2} ) {x}^{6} where$$

$${f}_{0} ( x ) = {a}_{0} + {a}_{1} x + {a}_{2} {x}^{2} , {f}_{1} ( x ) = {a}_{3} + {a}_{4} x + {a}_{5} {x}^{2} ,$$

$${f}_{2} ( x ) = {a}_{6} + {a}_{7} x + {a}_{8} {x}^{2} , {a}_{8} = 0 .$$

At this time, the second party prepares h₁(x)=x³modg(x) and h₂(x)=x⁶modg(x).

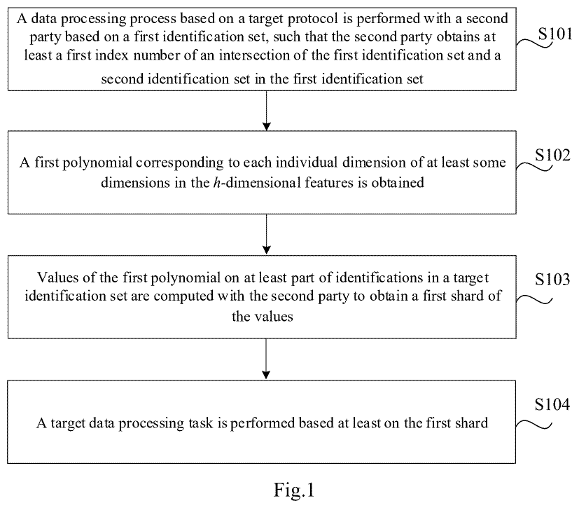

FIG. 1 is a flowchart of a method of data processing for secure computation applied to a first party according to an exemplary embodiment. As shown in FIG. 1, the method may include S101-S104.

In S101, a data processing process based on a target protocol is performed with a second party based on a first identification set, such that the second party obtains at least a first index number of an intersection of the first identification set and a second identification set in the first identification set.

In the present disclosure, the first party and the second party jointly perform the data processing process based on the target protocol, that is, jointly execute the target protocol, and the second party obtains at least the first index number of the intersection of the first identification set and the second identification set in the first identification set. The target protocol may be used to synchronize the first index number of the intersection in the first identification set to the second party, and when the identification in the second identification set corresponds to a single-dimensional feature, the target protocol may also be used to store the feature of the second party corresponding to the intersection (i.e., the preceding single-dimensional feature) in the first party and the second party in the form of shards.

When the identification in the second identification set corresponds to a single-dimensional feature, by executing the target protocol, the second party may obtain the preceding first index number, the second index number of the intersection in the second identification set, and the fourth shard of the preceding single-dimensional feature corresponding to the intersection, and the first party may obtain the fifth shard of the preceding single-dimensional feature corresponding to the intersection. That is, when the identification in the second identification set corresponds to a single-dimensional feature, by executing the target protocol, both parties may obtain one shard of the feature of the second party corresponding to the intersection respectively, and in addition, the second party may also obtain the first index number and the second index number. The preceding second index number of the intersection in the second identification set is used to characterize the index position of the element in the preceding intersection that belongs to the second identification set.

When the identification in the second identification set does not correspond to any feature, by executing the target protocol, the second party may obtain the preceding first index number, and the first party does not obtain any feature. That is, when the identification in the second identification set does not correspond to any feature, by executing the target protocol, the second party may obtain the first index number, and the information obtained by the first party is empty.

In S102, a first polynomial corresponding to each individual dimension of at least some dimensions in the h-dimensional features is obtained.

In the present disclosure, the first polynomial is constructed based on the individual dimension corresponding to the identification (that is, each identification) in the third identification set, and the value of the first polynomial on any identification in the third identification set is the value of the individual dimension corresponding to the identification, that is, the first polynomial is constructed with the identification in the third identification set as the independent variable and the individual dimension as the dependent variable, and the degree of the first polynomial is less than or equal to the count of identifications in the third identification set.

The third identification set is generated based on the index numbers of the identifications in the first identification set, where new identifications may be assigned to each piece of data held by the first party (specifically, each identification in the first identification set) respectively, to obtain the third identification set. In one possible implementation, a root of unity with the order of the index number of the identification in the first identification set may be used as the new identification.

Exemplarily, the index numbers of the identifications in the first identification set are 0, 1, 2, . . . , N−1 in turn, and the third identification set includes ξ⁰, ξ¹, ξ², . . . , ξ^{N-1} where ξⁱ is the i-th primitive unity root, and i=0,1,2, . . . , N−1.

In addition, both parties may perform sharding on part of -dimensions in the h-dimensional features, and at this time, the first party may obtain the first polynomial corresponding to each individual dimension of the part of dimensions; both parties may also perform sharding on the h-dimensional features, and at this time, the first party may obtain the first polynomial corresponding to each individual dimension of the h-dimensional features, and at this time, a total of h first polynomials are obtained. The count of features to be sharded by the first party is not specifically limited in the present disclosure.

In S103, values of the first polynomial on at least part of identifications in a target identification set are computed with the second party to obtain a first shard of the values.

In the present disclosure, the target identification set is generated by the second party based on the first index number. After obtaining the first index number of the intersection of the first identification set and the second identification set in the first identification set through the target protocol, the second party may generate the target identification set according to the first index number in the same manner as the first party generates the third identification set. Then, the first party and the second party jointly compute the values of the first polynomial on the at least part of identifications in the target identification set, the first party may obtain the first shard of the values, and the second party may obtain the sixth shard of the values, that is, the values include two shards, which are the first shard and the sixth shard respectively. The values of the first polynomial on the at least part of identifications in the target identification set are the feature shards corresponding to the at least part of identifications in the target identification set.

In addition, the first party and the second party may jointly compute the values of the first polynomial on each identification in the target identification set, or may jointly compute the values of the first polynomial on part of identifications in the target identification set, which is not specifically limited in the present disclosure.

In S104, a target data processing task is performed based at least on the first shard.

In the present disclosure, when the identification in the second identification set corresponds to a single-dimensional feature, the first party may perform the target data processing task based on the first shard and the fifth shard, and the second party may perform the target data processing task based on the sixth shard and the fourth shard; when the identification in the second identification set does not correspond to any feature, the first party may perform the target data processing task only based on the first shard, and the second party may perform the target data processing task only based on the sixth shard.

The preceding target data processing task may be an SQL query task or a machine learning model training task.

In one implementation, when the target data processing task is an SQL query task, the first party and the second party may jointly perform an SQL query based on the feature shards held by themselves respectively to obtain query result shards respectively, and then, both parties respectively feed back the query result shards obtained by themselves to a querying party; and after receiving the query result shards sent by both parties, the querying party combines them to obtain the final query result.

Specifically, when the identification in the second identification set corresponds to a single-dimensional feature, the first party may jointly perform an SQL query with the second party based on the first shard and the fifth shard, to obtain a first query result shard, and then feed back the first query result shard to the querying party; correspondingly, the second party may jointly perform an SQL query with the first party based on the fourth shard and the sixth shard, to obtain a second query result shard, and then feed back the second query result shard to the querying party; finally, the querying party combines the first query result shard and the second query result shard to obtain the final query result.

When the identification in the second identification set does not correspond to any feature, the first party may jointly perform an SQL query with the second party based on the first shard, to obtain a first query result shard, and then feed back the first query result shard to the querying party; correspondingly, the second party may jointly perform an SQL query with the first party based on the sixth shard, to obtain a second query result shard, and then feed back the second query result shard to the querying party; finally, the querying party combines the first query result shard and the second query result shard to obtain the final query result.

In another implementation, when the target data processing task is a machine learning model training task, the second party may use the features of the first party to perform model training, where the first party and the second party may perform model training in an MPC manner based on the feature shards held by themselves respectively, to obtain model parameter shards respectively, and then, the first party sends the model parameter shard held by itself to the second party, and the second party combines the model parameter shard obtained from the first party with the model parameter shard held by itself, to obtain the model parameters of the corresponding model, thereby completing the model training of the second party. In this manner, when the second party lacks training data or has insufficient training data, the features of the first party may be used to perform model training, which can improve the accuracy of the model training while ensuring the data privacy of the first party.

Specifically, when the identification in the second identification set corresponds to a single-dimensional feature, the first party may jointly perform model training with the second party based on the first shard and the fifth shard, to obtain a first model parameter shard, and then feed back the first model parameter shard to the second party; correspondingly, the second party may jointly perform model training with the first party based on the fourth shard and the sixth shard, to obtain a second model parameter shard, and then combine the second model parameter shard with the first model parameter shard received from the first party, to obtain the complete model parameters.

When the identification in the second identification set does not correspond to any feature, the first party may jointly perform model training with the second party based on the first shard, to obtain a first model parameter shard, and then feed back the first model parameter shard to the second party; correspondingly, the second party may jointly perform model training with the first party based on the sixth shard, to obtain a second model parameter shard, and then combine the second model parameter shard with the first model parameter shard received from the first party, to obtain the complete model parameters.

In the preceding technical solutions, firstly, the first party and the second party jointly perform the data processing process based on the target protocol, and the second party obtains at least the first index number of the intersection of the first identification set and the second identification set in the first identification set; then, the second party generates the target identification set based on the first index number, while the first party obtains the first polynomial corresponding to each individual dimensions of the at least some dimensions in the h-dimensional features held by itself; next, the first party and the second party compute the values of the first polynomial on the at least part of identifications in the target identification set to obtain one shard of the values respectively; and finally, the first party and the second party perform the target data processing task based on the shards held by themselves respectively. In this manner, the problem of sharding the feature corresponding to the intersection of the identification sets held by both parties can be skillfully converted into the problem of polynomial evaluation. The first party synchronizes the first index number which has no substantial physical meaning to the second party, such that the second party locally generates the target identification set based on the first index number, instead of directly synchronizing the target identification set to the second party, which not only can reduce the communication volume, but also can avoid data leakage of the first party. In addition, both parties use the target identification set instead of the intersection to compute values of the first polynomial on the intersection, and thus even if the second identification set is not a subset of the first identification set, it can be ensured that the obtained feature shard is an accurate result of the feature shard corresponding to the intersection, thereby ensuring the accuracy of the feature shard and enabling reliable execution of the target data processing task. Furthermore, both parties do not need to compute the intersection, but use the target identification set to replace the intersection, which can avoid the problem of data leakage caused by any party computing the intersection. Therefore, through the solution, data security can be protected and accuracy can be ensured in scenarios such as model training and SQL query.

The specific implementations of performing the data processing process based on the target protocol with the second party based on the first identification set, such that the second party to obtain at least the first index number of the intersection of the first identification set and the second identification set in the first identification set in S101 will be described in detail below.

Specifically, when the identification in the second identification set corresponds to a single-dimensional feature, the first party may perform the data processing process based on the target protocol through the following steps (a1)-(a4):

Step (a1): an oblivious pseudo-random function protocol is executed with the second party to obtain a first blinding factor and a second shard of the single-dimensional feature corresponding to the second identification set.

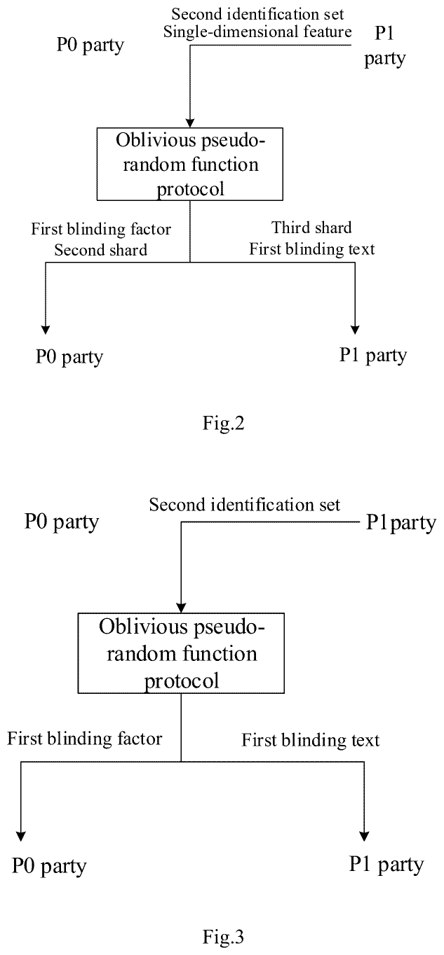

In the present disclosure, the first party and the second party may jointly execute an Oblivious Pseudo-Random Function (OPRF) protocol, where as shown in FIG. 2, the second party P1 may execute the OPRF protocol based on the second identification set and the preceding single-dimensional feature, the input of the first party P0 is empty, and after the OPRF protocol is executed, the first party P0 may obtain the first blinding factor and the second shard of the single-dimensional feature corresponding to the second identification set, and the second party P1 may obtain the third shard of the single-dimensional feature corresponding to the second identification set and a first blind text based on the second identification set.

Exemplarily, the preceding second shard is rⱼ, j=0, 1, 2, . . . , n−1, rⱼ is the second shard of the single-dimensional feature corresponding to the j-th identification in the second identification set, and n is the count of identifications in the second identification set.

Step (a2): hash values of the identifications in the first identification set are blinded with the first blinding factor to obtain a second blind text.

In the present disclosure, after obtaining the first blinding factor through the OPRF protocol, the first party may blind the hash value of each identification in the first identification set with the first blinding factor to obtain the second blind text.

Exemplarily, the first party may blind the hash values of the identifications in the first identification set with the first blinding factor through the following equation to obtain the second blind text:

$$M 2 = {k}_{0} * H ( {y}_{p} )$$

where M2 is the second blind text; k₀ is the first blinding factor; H(yₚ) is the hash value of the p-th identification yₚ in the first identification set, and p=0, 1, 2, . . . , N−1.

Step (a3): the second blind text is sent to the second party, so that the second party performs an intersection operation on the first blind text and the second blind text to obtain the first index number, the second index number of the intersection in the second identification set, and the fourth shard of the single-dimensional feature corresponding to the intersection, and sends the second index number to the first party.

Step (a4): the fifth shard of the single-dimensional feature corresponding to the intersection is selected from the second shard according to the received second index number.

In the present disclosure, after blinding the hash values of the identifications in the first identification set to obtain the second blind text, the first party may send the second blind text to the second party; after receiving the second blind text, the second party performs an intersection operation on the first blind text obtained through the OPRF protocol and the second blind text to obtain the first index number and the second index number of the intersection in the second identification set; then, the second party selects the fourth shard of the single-dimensional feature corresponding to the intersection from the third shard obtained through the OPRF protocol according to the second index number, and sends the second index number to the first party; and after receiving the second index number, the first party selects the fifth shard of the single-dimensional feature corresponding to the intersection from the second shard obtained through the OPRF protocol.

Exemplarily, n=9, the preceding second shard includes r₀, r₁, . . . , r₈, and the second index number is 1, 5, and 7, then the fifth shard includes r₁, r₅, r₇.

The second party may select the fourth shard of the single-dimensional feature corresponding to the intersection from the third shard according to the second index number in a similar manner to selecting the fifth shard of the single-dimensional feature corresponding to the intersection from the second shard, which will not be repeated in the present disclosure.

When the identification in the second identification set does not correspond to any feature, the first party may perform the data processing process based on the target protocol through the following steps (b1)-(b4):

Step (b1): an oblivious pseudo-random function protocol is executed with the second party to obtain a first blinding factor.

In the present disclosure, the first party and the second party may jointly execute the OPRF protocol, where as shown in FIG. 3, the second party P1 executes the oblivious pseudo-random function protocol based on the second identification set, the input of the first party is empty, and after the OPRF protocol is executed, the first party P0 may obtain the first blinding factor, and the second party P1 may obtain the first blind text based on the second identification set.

Step (b2): hash values of the identifications in the first identification set are blinded with the first blinding factor to obtain a second blind text.

Step (b3): the second blind text is sent to the second party, so that the second party performs an intersection operation on the first blind text and the second blind text to obtain the first index number.

In the present disclosure, after blinding the hash values of the identifications in the first identification set to obtain the second blind text, the first party may send the second blind text to the second party; and after receiving the second blind text, the second party performs an intersection operation on the first blind text obtained through the OPRF protocol and the second blind text to obtain the first index number.

The specific implementations of executing the oblivious pseudo-random function protocol with the second party to obtain the first blinding factor and the second shard of the single-dimensional feature corresponding to the second identification set in the preceding step (a1) will be described in detail below. Specifically, the preceding step (a1) may be implemented through the following steps (all)-(a13).

Step (a11): in response to receiving a ciphertext feature and a third blind text sent by the second party, scrambling an order of the ciphertext feature and an order of the third blind text, and generating n random variables and the first blinding factor.

In the present disclosure, the ciphertext feature is obtained by the second party through homomorphic encryption on the single-dimensional feature, and the third blind text is obtained by the second party by blinding hash values of the identifications in the second identification set.

Step (a12): the ciphertext feature obtained after the order scrambling is masked with the n random variables to obtain masked data, the third blind text obtained after the order scrambling is blinded with the first blinding factor to obtain a fourth blind text, and the masked data and the fourth blind text are sent to the second party, so that the second party performs homomorphic decryption on the masked data to obtain the third shard, and performs de-blinding on the fourth blind text to obtain the first blind text.

Step (a13): the n random variables are determined as the second shard.

In the present disclosure, when the first party and the second party jointly execute the OPRF protocol, the second party firstly generates a second blinding factor (randomly generated), and blinds the hash values of the identifications in the second identification set with the second blinding factor to obtain the third blind text; at the same time, the second party may perform homomorphic encryption on the preceding single-dimensional feature held by itself with a locally generated target homomorphic encryption private key to obtain the ciphertext feature; then, the second party sends the ciphertext feature and the third blind text to the first party; after receiving the ciphertext feature and the third blind text, the first party scrambles the order of the ciphertext feature and the order of the third blind text, and generates n random variables and the first blinding factor (randomly generated); then, the first party masks the ciphertext feature obtained after the order scrambling with the n random variables to obtain the masked data, and blinds the third blind text obtained after the order scrambling with the first blinding factor to obtain the fourth blind text; next, the first party sends the masked data and the fourth blind text to the second party; and after receiving the masked data and the fourth blind text, the second party performs homomorphic decryption on the masked data with the preceding target homomorphic encryption private key to obtain the preceding third shard, and performs de-blinding on the fourth blind text with the second blinding factor to obtain the first blind text; at the same time, the first party determines the n random variables locally generated as the second shard.

Exemplarily, the first party may mask the ciphertext feature obtained after the order scrambling with the n random variables through the following equation to obtain the masked data:

$${YG}_{j} = {E}_{{k}_{1}^{′}} ( {p}_{j} - {d}_{j} )$$

where YGⱼ is the j-th masked data; k₁ is the preceding target homomorphic encryption private key; pⱼ is the single-dimensional feature corresponding to the j-th identification in the second identification set; Eₖ_{_{1′}} (pⱼ) is the j-th ciphertext feature in the ciphertext feature obtained after the order scrambling; and dⱼ is the j-th random variable, j=0,1,2, . . . , n−1.

It should be noted that the second party may blind the hash values of the identifications in the second identification set with the second blinding factor in a similar manner as the preceding blinding the hash values of the identifications in the first identification set with the first blinding factor, which will not be repeated in the present disclosure.

In the preceding implementation, after receiving the ciphertext feature and the third blind text, the first party firstly scrambles the order of the ciphertext feature and the order of the third blind text, and then, the first party masks the ciphertext feature obtained after the order scrambling with the n locally generated random variables to obtain the masked data, and blinds the third blind text obtained after the order scrambling with the locally generated first blinding factor to obtain the fourth blind text, and sends the masked data and the fourth blind text to the second party, so that the second party can be prevented from learning the correspondence between the masked data and the ciphertext feature and the correspondence between the third blind text and the fourth blind text, and then inferring the second shard, thereby preventing the second shard held by the first party from being leaked to the second party.

The specific implementations of executing the oblivious pseudo-random function protocol with the second party to obtain the first blinding factor in the preceding step (b1) will be described in detail below. Specifically, the preceding step (b1) may be implemented through the following steps (b11) and (b12).

Step (b11): in response to receiving a third blind text sent by the second party, an order of the third blind text is scrambled and the first blinding factor is generated.

In the present disclosure, the third blind text is obtained by the second party by blinding hash values of the identifications in the second identification set.

Step (b12): the third blind text obtained after the order scrambling is blinded with the first blinding factor to obtain the fourth blind text, and the fourth blind text is sent to the second party, so that the second party performs de-blinding on the fourth blind text to obtain the first blind text.

In the present disclosure, when the first party and the second party jointly execute the OPRF protocol, the second party firstly generates a second blinding factor (randomly generated), and blinds the hash values of the identifications in the second identification set with the second blinding factor to obtain the third blind text; then, the second party sends the third blind text to the first party; after receiving the third blind text, the first party scrambles the order of the third blind text and generates the first blinding factor (randomly generated); then, the first party blinds the third blind text obtained after the order scrambling with the first blinding factor to obtain the fourth blind text; next, the first party sends the fourth blind text to the second party; and after receiving the fourth blind text, the second party performs de-blinding on the fourth blind text with the second blinding factor to obtain the first blind text.

In the preceding implementation, after receiving the third blind text, the first party firstly scrambles the order of the third blind text, and then, the first party blinds the third blind text obtained after the order scrambling with the locally generated first blinding factor to obtain the fourth blind text, and sends the fourth blind text to the second party, so that the second party can be prevented from learning the correspondence between the third blind text and the fourth blind text, and then inferring the first blinding factor.

The specific implementations of obtaining the first polynomial corresponding to the individual dimension in S102 will be described in detail below.

In one implementation, the first party may construct the first polynomial through an interpolation method, such that the first polynomial f(x)∈F[x] satisfies f(ξⁱ)=zᵢ, where zᵢ is the value of the individual dimension corresponding to the i-th identification in the third identification set, that is, the value of the first polynomial on the corresponding identification in the third identification set is the value of the individual dimension corresponding to the identification, and i=0,1,2, . . . , N−1.

The first party may construct the first polynomial through various interpolation methods, and in one implementation, the first party may construct the first polynomial through the Lagrange interpolation method, where the complexity of constructing the first polynomial in this manner is O(N³).

In another implementation, the first party may perform polynomial interpolation on the individual dimension corresponding to the identification in the third identification set by using the fast Fourier transform method, to obtain the first polynomial corresponding to the individual dimension. The complexity of constructing the first polynomial in this manner is O(NlogN). Therefore, preferably, the fast Fourier transform method may be used to construct the first polynomial, to reduce the complexity of polynomial construction, thereby improving the execution efficiency of the target data processing task.

In the present disclosure, the first polynomial may be constructed online, and in order to improve the execution efficiency of the target data processing task, the first polynomial may also be constructed offline (that is, the first polynomial is pre-constructed).

The specific implementations of computing the values of the first polynomial on the at least part of identifications in the target identification set with the second party to obtain the first shard of the values in S103 will be described in detail below. Specifically, the preceding S103 may be implemented through the following steps (c1) and (c2).

Step (c1): in response to receiving a ciphertext polynomial sent by the second party, a degree reduction process is performed on the first polynomial according to the ciphertext polynomial to obtain a second polynomial.

In the present disclosure, the ciphertext polynomial is generated by the second party based on the target identification set. Specifically, the second party may construct a fourth polynomial based on the target identification set, and perform homomorphic encryption on the fourth polynomial to obtain the ciphertext polynomial.

Exemplarily, the fourth polynomial may be constructed based on the target identification set through the following equation:

$${h}_{k} ( x ) = {x}^{kq} mod g ( x ) k = 0 , 1 , 2 , … , L$$

where there are L+1 fourth polynomials, hₖ(x) is the k-th fourth polynomial, and the second party obtains N through interaction with the first party.

After constructing the L+1 fourth polynomials, the second party may respectively perform homomorphic encryption on the L+1 fourth polynomials with the locally generated first homomorphic encryption private key to obtain L+1 ciphertext polynomials, and send them to the first party. The k-th ciphertext polynomial is obtained by the second party by performing homomorphic encryption on hₖ (x) (that is, x^{kq}modg(x)).

After receiving the ciphertext polynomial sent by the second party, the first party may perform the degree reduction process on the first polynomial according to the ciphertext polynomial to obtain the second polynomial.

Step (c2): values of the second polynomial on the at least part of identifications in the target identification set are computed with the second party to obtain the first shard.

In the present disclosure, after the first party and the second party jointly compute the values of the second polynomial on the at least part of identifications in the target identification set, the first party may obtain the first shard of the values, and the second party may obtain the sixth shard of the values. The values of the second polynomial on the at least part of identifications in the target identification set are the feature shards corresponding to the at least part of identifications in the target identification set.

The specific implementations of performing the degree reduction process on the first polynomial according to the ciphertext polynomial to obtain the second polynomial in the preceding step (c1) will be described in detail below. Specifically, the preceding step (c1) may be implemented through the following steps (c11)-(c13).

Step (c11): the first polynomial is converted into the form of

$${\sum }_{k = 0}^{⌊ N / q ⌋} {f}_{k} ( x ) {x}^{kq} .$$

Step (c12): fₖ(x) is multiplied by the k-th ciphertext polynomial to obtain a fifth polynomial, where k=0,1,2, . . . , L.

fₖ(x) is the plaintext, and the ciphertext polynomial is the ciphertext, and at this time, the plaintext-ciphertext multiplication protocol may be used to multiply the plaintext by the ciphertext to obtain the fifth polynomial.

Step (c13): a sum of each fifth polynomial and f₀(x) is determined as the second polynomial.

The sum of each fifth polynomial and f₀(x) is

$${\sum }_{k = 0}^{⌊ N / q ⌋} {f}_{k} ( x ) {h}_{k} ( x ) ,$$

which is equal to \tilde{f}(x), that is, the second polynomial f(x) is obtained.

The specific implementations of computing the values of the second polynomial on the at least part of identifications in the target identification set with the second party to obtain the first shard in the preceding step (c2) will be described in detail below. Specifically, the preceding step (c2) may be implemented through the following steps (c21)-(c23).

Step (c21): a random polynomial with the same degree as the second polynomial is generated.

Step (c22): the second polynomial is masked with the random polynomial to obtain a masked polynomial, and the masked polynomial is sent to the second party, so that the second party decrypts the masked polynomial to obtain a third polynomial.

Specifically, the difference between the second polynomial and the random polynomial may be determined as the masked polynomial and sent to the second party; after receiving the masked polynomial, the second party may decrypt it with the first homomorphic encryption private key to obtain the third polynomial.

Step (c23): a shared polynomial evaluation protocol is executed with the second party based on the random polynomial to obtain the first shard of the values of the second polynomial on the at least part of identifications in the target identification set, where the second party executes the shared polynomial evaluation protocol based on the third polynomial.

In the present disclosure, the first party may base on the random polynomial, and the second party may base on the third polynomial to jointly execute the shared polynomial evaluation protocol, so as to obtain the shards of the values of the second polynomial on the at least part of identifications in the target identification set respectively.

Specifically, the first party may perform homomorphic encryption on the coefficient vector of the random polynomial with the locally generated second homomorphic encryption private key to obtain an encryption vector, and send it to the second party; after receiving the encryption vector, the second party may generate a difference vector based on the encryption vector and the third polynomial, and send it to the first party; and the first party decrypts the received difference vector with the second homomorphic encryption private key to obtain the first shard of the values of the second polynomial on the at least part of identifications in the target identification set.

The second party may generate the difference vector based on the encryption vector and the third polynomial in the following manner:

Firstly, a sixth polynomial is generated with the sum of the coefficient vector of the third polynomial and the encryption vector as the coefficient vector; then, each identification in the at least part of identifications in the target identification set is respectively substituted into the sixth polynomial to obtain a result vector, where after each identification in the at least part of identifications in the target identification set is substituted into the sixth polynomial, the value of the sixth polynomial on the identification may be obtained, and these values constitute the result vector; then, a random vector with the same length as the result vector is generated, and the difference between the result vector and the random vector is determined as the difference vector. The second party uses the random vector as the sixth shard of the values of the second polynomial on the at least part of identifications in the target identification set.

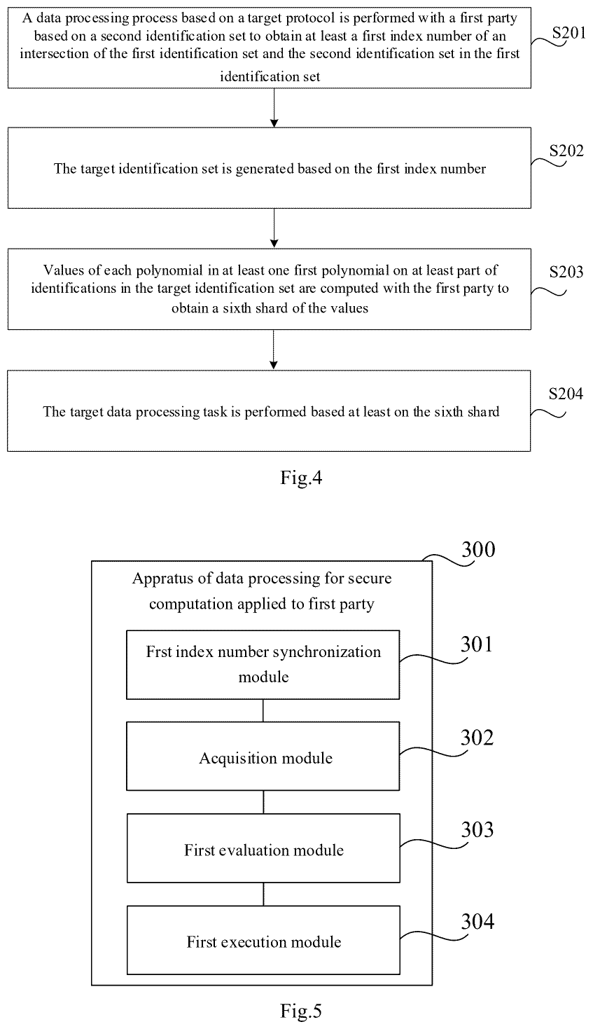

FIG. 4 is a flowchart of a method of data processing for secure computation applied to a second party according to an exemplary embodiment. As shown in FIG. 4, the method may include S201-S204.

In S201, a data processing process based on a target protocol is performed with a first party based on a second identification set to obtain at least a first index number of an intersection of the first identification set and the second identification set in the first identification set.

In the present disclosure, the parties involved in the secure computation include a first party and a second party, the first party holds a first identification set, identifications in the first identification set correspond to h-dimensional features, the second party holds a second identification set, and h≥1.

In S202, the target identification set is generated based on the first index number.

In S203, values of each polynomial in at least one first polynomial on at least part of identifications in the target identification set are computed with the first party to obtain a sixth shard of the values.

The at least one first polynomial is constructed by the first party for each individual dimension of the at least some dimensions in the h-dimensional features based on the individual dimension corresponding to the identification in the third identification set, the third identification set is generated by the first party based on the index numbers of the identifications in the first identification set, and the third identification set and the target identification set are generated in the same manner;

In S204, the target data processing task is performed based at least on the sixth shard.

In the preceding technical solutions, firstly, the first party and the second party jointly perform the data processing process based on the target protocol, and the second party obtains at least the first index number of the intersection of the first identification set and the second identification set in the first identification set; then, the second party generates the target identification set based on the first index number, while the first party obtains the first polynomial corresponding to each individual dimension of the at least some dimensions in the h-dimensional features held by itself; next, the first party and the second party compute the values of the first polynomial on the at least part of identifications in the target identification set to obtain one shard of the values respectively; and finally, the first party and the second party perform the target data processing task based on the shards held by themselves respectively. In this manner, the problem of sharding the feature corresponding to the intersection of the identification sets held by both parties can be skillfully converted into the problem of polynomial evaluation. The first party synchronizes the first index number which has no substantial physical meaning to the second party, such that the second party locally generates the target identification set based on the first index number, instead of directly synchronizing the target identification set to the second party, which not only can reduce the communication volume, but also can avoid data leakage of the first party. In addition, both parties use the target identification set instead of the intersection to compute the values of the first polynomial on the intersection, and thus even if the second identification set is not a subset of the first identification set, it can be ensured that the obtained feature shard is an accurate result of the feature shard corresponding to the intersection, thereby ensuring the accuracy of the feature shard and enabling reliable execution of the target data processing task. Furthermore, both parties do not need to compute the intersection, but use the target identification set to replace the intersection, which can avoid the problem of data leakage caused by any party computing the intersection. Therefore, through the solution, data security can be protected and accuracy can be ensured in scenarios such as model training and SQL query.

Optionally, the identification in the second identification set corresponds to a single-dimensional feature; and performing the data processing process based on the target protocol with the first party based on the second identification set to obtain at least the first index number of the intersection of the first identification set and the second identification set in the first identification set includes: executing an oblivious pseudo-random function protocol with the first party based on the second identification set and the single-dimensional feature to obtain a third shard of the single-dimensional feature corresponding to the second identification set and a first blind text based on the second identification set; in response to receiving a second blind text sent by the first party, performing an intersection operation on the first blind text and the second blind text to obtain the first index number and a second index number of the intersection in the second identification set, where the second blind text is obtained by the first party by blinding hash values of the identifications in the first identification set; and selecting a fourth shard of the single-dimensional feature corresponding to the intersection from the third shard according to the second index number, and sending the second index number to the first party, so that the first party obtains a fifth shard of the single-dimensional feature corresponding to the intersection according to the second index number.

Optionally, executing the oblivious pseudo-random function protocol with the first party based on the second identification set and the single-dimensional feature to obtain the third shard of the single-dimensional feature corresponding to the second identification set and the first blind text based on the second identification set includes: generating a second blinding factor, and blinding hash values of the identifications in the second identification set with the second blinding factor to obtain a third blind text; performing homomorphic encryption on the single-dimensional feature to obtain a ciphertext feature; sending the ciphertext feature and the third blind text to the first party, so that the first party masks the ciphertext feature to obtain masked data, and blinds the third blind text to obtain a fourth blind text, and sends the masked data and the fourth blind text to the second party; and performing homomorphic decryption on the received masked data to obtain the third shard, and performing de-blinding on the received fourth blind text with the second blinding factor to obtain the first blind text.

Optionally, performing the target data processing task based at least on the sixth shard includes: performing the target data processing task based on the sixth shard and the fourth shard.

Optionally, the identification in the second identification set does not correspond to any feature; and performing the data processing process based on the target protocol with the first party based on the second identification set to obtain at least the first index number of the intersection of the first identification set and the second identification set in the first identification set includes: executing an oblivious pseudo-random function protocol with the first party based on the second identification set to obtain the first blind text based on the second identification set; and in response to receiving a second blind text sent by the first party, performing an intersection operation on the first blind text and the second blind text to obtain the first index number, where the second blind text is obtained by the first party by blinding hash values of the identifications in the first identification set.

Optionally, executing the oblivious pseudo-random function protocol with the first party based on the second identification set to obtain the first blind text based on the second identification set includes: generating a second blinding factor, and blinding hash values of the identifications in the second identification set with the second blinding factor to obtain a third blind text; sending the third blind text to the first party, so that the first party blinds the third blind text to obtain a fourth blind text, and sends the fourth blind text to the second party; and performing de-blinding on the received fourth blind text with the second blinding factor to obtain the first blind text.

Optionally, computing the values of the first polynomial on the at least part of identifications in the target identification set with the first party to obtain the sixth shard of the values includes: constructing a fourth polynomial based on the target identification set, and performing homomorphic encryption on the fourth polynomial to obtain a ciphertext polynomial; sending the ciphertext polynomial to the first party, so that the first party performs a degree reduction process on the first polynomial corresponding to each individual dimension of the at least some dimensions in the h-dimensional features according to the ciphertext polynomial to obtain a second polynomial; and computing values of the second polynomial on the at least part of identifications in the target identification set with the first party to obtain the sixth shard.

Optionally, computing the values of the second polynomial on the at least part of identifications in the target identification set with the first party to obtain the sixth shard of the values includes: in response to receiving a masked polynomial sent by the first party, decrypting the masked polynomial to obtain a third polynomial, where the masked polynomial is obtained by the first party by masking a random polynomial generated by the first party; and executing a shared polynomial evaluation protocol with the first party based on the third polynomial to obtain the sixth shard of the values of the second polynomial on the at least part of identifications in the target identification set, where the first party executes the shared polynomial evaluation protocol based on the random polynomial. The specific implementations of the steps in the method of data processing for secure computation applied to the second party according to the embodiments of the present disclosure have been described in detail in the method of data processing for secure computation applied to the first party according to the embodiments of the present disclosure, which will not be repeated here.

FIG. 5 is a block diagram of an apparatus of data processing for secure computation applied to a first party according to an exemplary embodiment. The parties involved in the secure computation include a first party and a second party, the first party holds a first identification set, identifications in the first identification set correspond to h-dimensional features, the second party holds a second identification set, and h 1. As shown in FIG. 5, the apparatus 300 includes: a first index number synchronization module 301, configured to perform a data processing process based on a target protocol with the second party based on the first identification set, so that the second party obtains at least a first index number of an intersection of the first identification set and the second identification set in the first identification set; an acquisition module 302, configured to obtain a first polynomial corresponding to each individual dimension of at least some dimensions in the h-dimensional features, where the first polynomial is constructed based on an individual dimension corresponding to an identification in a third identification set, and the third identification set is generated based on index numbers of the identifications in the first identification set; a first evaluation module 303, configured to compute values of the first polynomial on at least part of identifications in a target identification set with the second party to obtain a first shard of the values, where the target identification set is generated by the second party based on the first index number, and the third identification set and the target identification set are generated in the same manner; and a first execution module 304, configured to perform a target data processing task based at least on the first shard.

In the preceding technical solutions, firstly, the first party and the second party jointly perform the data processing process based on the target protocol, and the second party obtains at least the first index number of the intersection of the first identification set and the second identification set in the first identification set; then, the second party generates the target identification set based on the first index number, while the first party obtains the first polynomial corresponding to each individual dimension of the at least some dimensions in the h-dimensional features held by itself; next, the first party and the second party compute the values of the first polynomial on the at least part of identifications in the target identification set to obtain one shard of the values respectively; and finally, the first party and the second party perform the target data processing task based on the shards held by themselves respectively. In this manner, the problem of sharding the feature corresponding to the intersection of the identification sets held by both parties can be skillfully converted into the problem of polynomial evaluation. The first party synchronizes the first index number which has no substantial physical meaning to the second party, such that the second party locally generates the target identification set based on the first index number, instead of directly synchronizing the target identification set to the second party, which not only can reduce the communication volume, but also can avoid data leakage of the first party. In addition, both parties use the target identification set instead of the intersection to compute the values of the first polynomial on the intersection, and thus even if the second identification set is not a subset of the first identification set, it can be ensured that the obtained feature shard is an accurate result of the feature shard corresponding to the intersection, thereby ensuring the accuracy of the feature shard and enabling reliable execution of the target data processing task. Furthermore, both parties do not need to compute the intersection, but use the target identification set to replace the intersection, which can avoid the problem of data leakage caused by any party computing the intersection. Therefore, through the solution, data security can be protected and accuracy can be ensured in scenarios such as model training and SQL query.

Optionally, the identification in the second identification set corresponds to a single-dimensional feature; the first index number synchronization module 301 includes: a first execution sub-module, configured to execute an oblivious pseudo-random function protocol with the second party to obtain a first blinding factor and a second shard of the single-dimensional feature corresponding to the second identification set, where the second party executes the oblivious pseudo-random function protocol based on the second identification set and the single-dimensional feature to obtain a third shard of the single-dimensional feature corresponding to the second identification set and a first blind text based on the second identification set; a first blinding sub-module, configured to blind hash values of the identifications in the first identification set with the first blinding factor to obtain a second blind text; a first sending sub-module, configured to send the second blind text to the second party, so that the second party performs an intersection operation on the first blind text and the second blind text to obtain the first index number, a second index number of the intersection in the second identification set, and a fourth shard of the single-dimensional feature corresponding to the intersection, and sends the second index number to the first party; and a first selection sub-module, configured to select a fifth shard of the single-dimensional feature corresponding to the intersection from the second shard according to the received second index number.

Optionally, the first execution sub-module includes: a first scrambling sub-module, configured to scramble an order of the ciphertext feature and an order of the third blind text and generate n random variables and the first blinding factor in response to receiving the ciphertext feature and the third blind text sent by the second party, where the ciphertext feature is obtained by the second party by performing homomorphic encryption on the single-dimensional feature, n is the count of the identifications in the second identification set, and the third blind text is obtained by the second party by blinding hash values of the identifications in the second identification set; a first processing sub-module, configured to mask the ciphertext feature obtained after the order scrambling with the n random variables to obtain masked data, blind the third blind text obtained after the order scrambling with the first blinding factor to obtain a fourth blind text, and send the masked data and the fourth blind text to the second party, so that the second party performs homomorphic decryption on the masked data to obtain the third shard, and performs de-blinding on the fourth blind text to obtain the first blind text; and a determination sub-module, configured to determine the n random variables as the second shard.

Optionally, the first execution module 304 is configured to perform the target data processing task based on the first shard and the fifth shard.

Optionally, the identification in the second identification set does not correspond to any feature; the first index number synchronization module 301 includes: a second execution sub-module, configured to execute an oblivious pseudo-random function protocol with the second party to obtain a first blinding factor, where the second party executes the oblivious pseudo-random function protocol based on the second identification set to obtain the first blind text based on the second identification set; a first blinding sub-module, configured to blind hash values of the identifications in the first identification set with the first blinding factor to obtain a second blind text; and a second sending sub-module, configured to send the second blind text to the second party, so that the second party performs an intersection operation on the first blind text and the second blind text to obtain the first index number.

Optionally, the second execution sub-module includes: a second scrambling sub-module, configured to scramble an order of the third blind text and generate the first blinding factor in response to receiving the third blind text sent by the second party, where the third blind text is obtained by the second party by blinding hash values of the identifications in the second identification set; and a second processing sub-module, configured to blind the third blind text obtained after the order scrambling with the first blinding factor to obtain a fourth blind text, and send the fourth blind text to the second party, so that the second party performs de-blinding on the fourth blind text to obtain the first blind text.

Optionally, the acquisition module 302 is configured to perform polynomial interpolation on the individual dimension corresponding to the identification in the third identification set by using the fast Fourier transform method to obtain the first polynomial corresponding to the individual dimension.

Optionally, the first evaluation module 303 includes: a degree reduction sub-module, configured to perform a degree reduction process on the first polynomial according to a ciphertext polynomial sent by the second party to obtain a second polynomial in response to receiving the ciphertext polynomial, where the ciphertext polynomial is generated by the second party based on the target identification set; and a first computing sub-module, configured to compute values of the second polynomial on the at least part of identifications in the target identification set with the second party to obtain the first shard.

Optionally, the first computing sub-module includes: a generation sub-module, configured to generate the random polynomial with the same degree as the second polynomial; a third processing sub-module, configured to mask the second polynomial with the random polynomial to obtain the masked polynomial, and send the masked polynomial to the second party, so that the second party decrypts the masked polynomial to obtain the third polynomial; and a first evaluation sub-module, configured to execute the shared polynomial evaluation protocol with the second party based on the random polynomial to obtain the first shard of the values of the second polynomial on the at least part of identifications in the target identification set, where the second party executes the shared polynomial evaluation protocol based on the third polynomial.

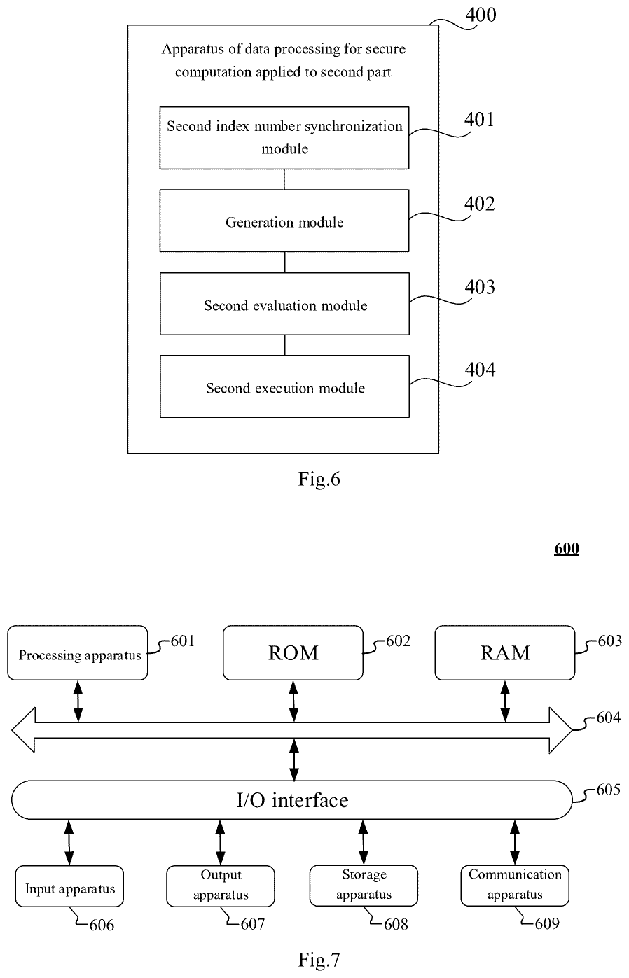

FIG. 6 is a block diagram of an apparatus of data processing for secure computation applied to a second party according to an exemplary embodiment. The parties involved in the secure computation include a first party and a second party, the first party holds a first identification set, identifications in the first identification set correspond to h-dimensional features, the second party holds a second identification set, and h≥1. As shown in FIG. 6, the apparatus 400 includes: a second index number synchronization module 401, configured to perform a data processing process based on a target protocol with the first party based on the second identification set to obtain at least a first index number of an intersection of the first identification set and the second identification set in the first identification set; a generation module 402, configured to generate a target identification set based on the first index number; a second evaluation module 403, configured to compute values of each polynomial in at least one first polynomial on at least part of identifications in the target identification set with the first party to obtain a sixth shard of the values, where the at least one first polynomial is constructed by the first party for each individual dimension of at least some dimensions in the h-dimensional features based on the individual dimension corresponding to the identification in the third identification set, the third identification set is generated by the first party based on the index numbers of the identifications in the first identification set, and the third identification set and the target identification set are generated in the same manner; and a second execution module 404, configured to perform a target data processing task based at least on the sixth shard.

In the preceding technical solutions, firstly, the first party and the second party jointly perform the data processing process based on the target protocol, and the second party obtains at least the first index number of the intersection of the first identification set and the second identification set in the first identification set; then, the second party generates the target identification set based on the first index number, while the first party obtains the first polynomial corresponding to each individual dimension of the at least some dimensions in the h-dimensional features held by itself; next, the first party and the second party compute the values of the first polynomial on the at least part of identifications in the target identification set to obtain one shard of the values respectively; and finally, the first party and the second party perform the target data processing task based on the shards held by themselves respectively. In this manner, the problem of sharding the feature corresponding to the intersection of the identification sets held by both parties can be skillfully converted into the problem of polynomial evaluation. The first party synchronizes the first index number which has no substantial physical meaning to the second party, such that the second party locally generates the target identification set based on the first index number, instead of directly synchronizing the target identification set to the second party, which not only can reduce the communication volume, but also can avoid data leakage of the first party. In addition, both parties use the target identification set instead of the intersection to compute the values of the first polynomial on the intersection, and thus even if the second identification set is not a subset of the first identification set, it can be ensured that the obtained feature shard is an accurate result of the feature shard corresponding to the intersection, thereby ensuring the accuracy of the feature shard and enabling reliable execution of the target data processing task. Furthermore, both parties do not need to compute the intersection, but use the target identification set to replace the intersection, which can avoid the problem of data leakage caused by any party computing the intersection. Therefore, through the solution, data security can be protected and accuracy can be ensured in scenarios such as model training and SQL query.

Optionally, the identification in the second identification set corresponds to a single-dimensional feature; the second index number synchronization module 401 includes: a third execution sub-module, configured to execute an oblivious pseudo-random function protocol with the first party based on the second identification set and the single-dimensional feature to obtain a third shard of the single-dimensional feature corresponding to the second identification set and a first blind text based on the second identification set; an intersection sub-module, configured to perform an intersection operation on the first blind text and the second blind text to obtain the first index number and a second index number of the intersection in the second identification set in response to receiving the second blind text sent by the first party, where the second blind text is obtained by the first party by blinding hash values of the identifications in the first identification set; and a second selection sub-module, configured to select a fourth shard of the single-dimensional feature corresponding to the intersection from the third shard according to the second index number, and send the second index number to the first party, so that the first party obtains a fifth shard of the single-dimensional feature corresponding to the intersection according to the second index number.

Optionally, the third execution sub-module includes: a second blinding sub-module, configured to generate a second blinding factor, and blind hash values of the identifications in the second identification set with the second blinding factor to obtain a third blind text; a homomorphic encryption sub-module, configured to perform homomorphic encryption on the single-dimensional feature to obtain a ciphertext feature; a third sending sub-module, configured to send the ciphertext feature and the third blind text to the first party, so that the first party masks the ciphertext feature to obtain masked data, and blinds the third blind text to obtain a fourth blind text, and sends the masked data and the fourth blind text to the second party; and a homomorphic decryption sub-module, configured to perform homomorphic decryption on the received masked data to obtain the third shard, and perform de-blinding on the received fourth blind text with the second blinding factor to obtain the first blind text.

Optionally, the second execution module 404 is configured to perform the target data processing task based on the sixth shard and the fourth shard.

Optionally, the identification in the second identification set does not correspond to any feature; the second index number synchronization module 401 includes: a fourth execution sub-module, configured to execute an oblivious pseudo-random function protocol with the first party based on the second identification set to obtain a first blind text based on the second identification set; and a fourth sending sub-module, configured to perform an intersection operation on the first blind text and the second blind text to obtain the first index number in response to receiving the second blind text sent by the first party, where the second blind text is obtained by the first party by blinding hash values of the identifications in the first identification set.

Optionally, the fourth execution sub-module includes: a second blinding sub-module, configured to generate a second blinding factor, and blind hash values of the identifications in the second identification set with the second blinding factor to obtain a third blind text; a fifth sending sub-module, configured to send the third blind text to the first party, so that the first party blinds the third blind text to obtain a fourth blind text, and sends the fourth blind text to the second party; and a de-blinding sub-module, configured to perform de-blinding on the received fourth blind text with the second blinding factor to obtain the first blind text.

Optionally, the second evaluation module 403 includes: a construction sub-module, configured to construct a fourth polynomial based on the target identification set, and perform homomorphic encryption on the fourth polynomial to obtain a ciphertext polynomial; a sixth sending sub-module, configured to send the ciphertext polynomial to the first party, so that the first party performs a degree reduction process on the first polynomial corresponding to each individual dimension of the at least some dimensions in the h-dimensional features according to the ciphertext polynomial to obtain a second polynomial; and a second computing sub-module, configured to compute values of the second polynomial on the at least part of identifications in the target identification set with the first party to obtain the sixth shard.

Optionally, the second computing sub-module includes: a polynomial decryption sub-module, configured to decrypt the masked polynomial sent by the first party to obtain a third polynomial in response to receiving the masked polynomial, where the masked polynomial is obtained by the first party by masking a random polynomial generated by the first party; and a second evaluation sub-module, configured to execute a shared polynomial evaluation protocol with the first party based on the third polynomial to obtain the sixth shard of the values of the second polynomial on the at least part of identifications in the target identification set, where the first party executes the shared polynomial evaluation protocol based on the random polynomial.

The present disclosure further provides a computer-readable medium having a computer program stored thereon, where when the program is executed by a processing apparatus, the steps of the preceding method of data processing for secure computation applied to the first party or the steps of the preceding method of data processing for secure computation applied to the second party provided by the present disclosure are implemented.

The present disclosure further provides a computer program product, including a computer program, where when the computer program is executed by a processor, the steps of the preceding method of data processing for secure computation applied to the first party or the steps of the preceding method of data processing for secure computation applied to the second party provided by the present disclosure are implemented.

Reference is made to FIG. 7 below, which illustrates a schematic structural diagram of an electronic device 600 (such as a terminal device or a server) suitable for implementing the embodiments of the present disclosure. The terminal device in the embodiments of the present disclosure may include, but is not limited to, mobile terminals such as a mobile phone, a notebook computer, a digital broadcast receiver, a personal digital assistant (PDA), a tablet computer, a portable multimedia player (PMP), and an in-vehicle terminal (such as an in-vehicle navigation terminal), and fixed terminals such as a digital TV and a desktop computer. The electronic device shown in FIG. 7 is merely an example, and should not impose any limitation to the function and usage scope of the embodiments of the present disclosure.

As shown in FIG. 7, the electronic device 600 may include a processing apparatus (such as a central processing unit or a graphics processor) 601, which may perform various appropriate actions and processing according to a program stored in a read-only memory (ROM) 602 or a program loaded from a storage apparatus 608 into a random access memory (RAM) 603. The RAM 603 further stores various programs and data required for operations of the electronic device 600. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 such as a touchscreen, a touchpad, a keyboard, a mouse, a camera, a microphone, an accelerometer, and a gyroscope; an output apparatus 607 such as a liquid crystal display (LCD), a speaker, and a vibrator; the storage apparatus 608 such as a magnetic tape and a hard disk; and a communication apparatus 609. The communication apparatus 609 may allow the electronic device 600 to perform wireless or wired communication with other devices to exchange data. Although FIG. 7 shows the electronic device 600 having various apparatuses, it should be understood that not all of the illustrated apparatuses are necessarily implemented or included. Alternatively, more or fewer apparatuses may be implemented or included.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, and the computer program includes program codes for executing the method shown in the flowchart. In such an embodiment, the computer program may be downloaded and installed from the network through the communication apparatus 609, or installed from the storage apparatus 608, or installed from the ROM 602. When the computer program is executed by the processing apparatus 601, the preceding functions defined in the method of the embodiments of the present disclosure are executed.

It should be noted that the preceding computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium containing or storing a program, and the program may be used by or in conjunction with an instruction execution system, apparatus, or device. In the present disclosure, the computer-readable signal medium may include a data signal propagated in baseband or as a part of a carrier wave, and computer-readable program codes are carried in the data signal. The data signal propagated in this manner may take a plurality of forms, including, but not limited to, an electromagnetic signal, an optical signal, or any suitable combination thereof. The computer-readable signal medium may also be any computer-readable medium other than the computer-readable storage medium, and the computer-readable signal medium may send, propagate, or transmit a program used by or in conjunction with the instruction execution system, apparatus, or device. The program codes contained in the computer-readable medium may be transmitted by any suitable medium, including, but not limited to, a wire, an optical cable, a radio frequency (RF), or any suitable combination thereof.

In some implementations, the client and the server may communicate using any currently known or future developed network protocol such as the hypertext transfer protocol (HTTP), and may be interconnected with any form or medium of digital data communication (e.g., a communication network). Examples of the communication network include a local area network (“LAN”), a wide area network (“WAN”), an internetwork (e.g., the Internet), and an end-to-end network (e.g., an ad hoc end-to-end network), as well as any currently known or future developed network.

The preceding computer-readable medium may be included in the preceding electronic device; or may exist alone without being assembled into the electronic device.

The preceding computer-readable medium carries one or more programs, and when the preceding one or more programs are executed by the electronic device, the electronic device is caused to: perform a data processing process based on a target protocol with a second party based on a first identification set, so that the second party obtains at least a first index number of an intersection of the first identification set and a second identification set in the first identification set, where the parties involved in the secure computation include a first party and the second party, the first party holds the first identification set, identifications in the first identification set correspond to h-dimensional features, the second party holds the second identification set, and h≥1; obtain a first polynomial corresponding to each individual dimension of at least some dimensions in the h-dimensional features, where the first polynomial is constructed based on an individual dimension corresponding to an identification in a third identification set, and the third identification set is generated based on index numbers of the identifications in the first identification set; compute values of the first polynomial on at least part of identifications in a target identification set with the second party to obtain a first shard of the values, where the target identification set is generated by the second party based on the first index number, and the third identification set and the target identification set are generated in the same manner; and perform a target data processing task based at least on the first shard.

Or, the preceding computer-readable medium carries one or more programs, and when the preceding one or more programs are executed by the electronic device, the electronic device is caused to: perform a data processing process based on a target protocol with a first party based on a second identification set to obtain at least a first index number of an intersection of a first identification set and the second identification set in the first identification set, where the parties involved in the secure computation include the first party and a second party, the first party holds the first identification set, identifications in the first identification set correspond to h-dimensional features, the second party holds the second identification set, and h≥1; generate a target identification set based on the first index number; compute values of each polynomial in at least one first polynomial on at least part of identifications in the target identification set with the first party to obtain a sixth shard of the values, where the at least one first polynomial is constructed by the first party for each individual dimension of at least some dimensions in the h-dimensional features based on an individual dimension corresponding to an identification in a third identification set, the third identification set is generated by the first party based on index numbers of the identifications in the first identification set, and the third identification set and the target identification set are generated in the same manner; and perform a target data processing task based at least on the sixth shard.

The computer program codes for performing the operations of the present disclosure may be written in one or more programming languages or a combination thereof. The preceding programming languages include object-oriented programming languages such as Java, Smalltalk, and C++, as well as conventional procedural programming languages such as “C” or similar programming languages. The program codes may be executed entirely on a user's computer, partly on the user's computer, as a stand-alone software package, partly on the user's computer and partly on a remote computer, or entirely on the remote computer or server. In the scenario involving the remote computer, the remote computer may be connected to the user's computer through any kind of network, including a local area network (LAN) or a wide area network (WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may occur out of the order noted in the drawings. For example, two blocks shown in succession may, in fact, be executed substantially concurrently, or the blocks may sometimes be executed in the reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules involved in the embodiments described herein may be implemented in software or hardware. The name of a module does not constitute a limitation of the module itself under certain circumstances. For example, a first execution module may also be described as “a module that performs a target data processing task based at least on the first shard”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof.

According to one or more embodiments of the present disclosure, Example 1 provides a method of data processing for secure computation. The parties involved in the secure computation include a first party and a second party, the first party holds a first identification set, identifications in the first identification set correspond to h-dimensional features, the second party holds a second identification set, and h≥1. The method is applied to the first party and includes: performing a data processing process based on a target protocol with the second party based on the first identification set, so that the second party obtains at least a first index number of an intersection of the first identification set and the second identification set in the first identification set; obtaining a first polynomial corresponding to each individual dimension of at least some dimensions in the h-dimensional features, where the first polynomial is constructed based on an individual dimension corresponding to an identification in a third identification set, and the third identification set is generated based on index numbers of the identifications in the first identification set; computing values of the first polynomial on at least part of identifications in a target identification set with the second party to obtain a first shard of the values, where the target identification set is generated by the second party based on the first index number, and the third identification set and the target identification set are generated in the same manner; and performing a target data processing task based at least on the first shard.

According to one or more embodiments of the present disclosure, Example 2 provides the method of Example 1, where the identification in the second identification set corresponds to a single-dimensional feature; and performing the data processing process based on the target protocol with the second party based on the first identification set, so that the second party obtains at least the first index number of the intersection of the first identification set and the second identification set in the first identification set includes: executing an oblivious pseudo-random function protocol with the second party to obtain a first blinding factor and a second shard of the single-dimensional feature corresponding to the second identification set, where the second party executes the oblivious pseudo-random function protocol based on the second identification set and the single-dimensional feature to obtain a third shard of the single-dimensional feature corresponding to the second identification set and a first blind text based on the second identification set; blinding hash values of the identifications in the first identification set with the first blinding factor to obtain a second blind text; sending the second blind text to the second party, so that the second party performs an intersection operation on the first blind text and the second blind text to obtain the first index number, a second index number of the intersection in the second identification set, and a fourth shard of the single-dimensional feature corresponding to the intersection, and sends the second index number to the first party; and selecting a fifth shard of the single-dimensional feature corresponding to the intersection from the second shard according to the received second index number.

According to one or more embodiments of the present disclosure, Example 3 provides the method of Example 2, where executing the oblivious pseudo-random function protocol with the second party to obtain the first blinding factor and the second shard of the single-dimensional feature corresponding to the second identification set includes: scrambling an order of the ciphertext feature and an order of the third blind text and generating n random variables and the first blinding factor in response to receiving the ciphertext feature and the third blind text sent by the second party, where the ciphertext feature is obtained by the second party by performing homomorphic encryption on the single-dimensional feature, n is the count of the identifications in the second identification set, and the third blind text is obtained by the second party by blinding hash values of the identifications in the second identification set; masking the ciphertext feature obtained after the order scrambling with the n random variables to obtain masked data, blinding the third blind text obtained after the order scrambling with the first blinding factor to obtain a fourth blind text, and sending the masked data and the fourth blind text to the second party, so that the second party performs homomorphic decryption on the masked data to obtain the third shard, and performs de-blinding on the fourth blind text to obtain the first blind text; and determining the n random variables as the second shard.

According to one or more embodiments of the present disclosure, Example 4 provides the method of Example 2, where performing the target data processing task based at least on the first shard includes: performing the target data processing task based on the first shard and the fifth shard.

According to one or more embodiments of the present disclosure, Example 5 provides the method of Example 1, where the identification in the second identification set does not correspond to any feature; and performing the data processing process based on the target protocol with the second party based on the first identification set, so that the second party obtains at least the first index number of the intersection of the first identification set and the second identification set in the first identification set includes: executing an oblivious pseudo-random function protocol with the second party to obtain a first blinding factor, where the second party executes the oblivious pseudo-random function protocol based on the second identification set to obtain the first blind text based on the second identification set; blinding hash values of the identifications in the first identification set with the first blinding factor to obtain a second blind text; and sending the second blind text to the second party, so that the second party performs an intersection operation on the first blind text and the second blind text to obtain the first index number.

According to one or more embodiments of the present disclosure, Example 6 provides the method of Example 5, where executing the oblivious pseudo-random function protocol with the second party to obtain the first blinding factor includes: scrambling an order of the third blind text and generating the first blinding factor in response to receiving the third blind text sent by the second party, where the third blind text is obtained by the second party by blinding hash values of the identifications in the second identification set; and blinding the third blind text obtained after the order scrambling with the first blinding factor to obtain a fourth blind text, and sending the fourth blind text to the second party, so that the second party performs de-blinding on the fourth blind text to obtain the first blind text.

According to one or more embodiments of the present disclosure, Example 7 provides the method of Example 1, where obtaining the first polynomial corresponding to the individual dimension includes: performing polynomial interpolation on the individual dimension corresponding to the identification in the third identification set by using the fast Fourier transform method to obtain the first polynomial corresponding to the individual dimension.

According to one or more embodiments of the present disclosure, Example 8 provides the method of Example 1, where computing the values of the first polynomial on the at least part of identifications in the target identification set with the second party to obtain the first shard of the values includes: performing a degree reduction process on the first polynomial according to the ciphertext polynomial to obtain a second polynomial in response to receiving the ciphertext polynomial sent by the second party, where the ciphertext polynomial is generated by the second party based on the target identification set; and computing values of the second polynomial on the at least part of identifications in the target identification set with the second party to obtain the first shard.

According to one or more embodiments of the present disclosure, Example 9 provides the method of Example 8, where computing the values of the second polynomial on the at least part of identifications in the target identification set with the second party to obtain the first shard of the values includes: generating the random polynomial with the same degree as the second polynomial; masking the second polynomial with the random polynomial to obtain the masked polynomial, and sending the masked polynomial to the second party, so that the second party decrypts the masked polynomial to obtain the third polynomial; and executing the shared polynomial evaluation protocol with the second party based on the random polynomial to obtain the first shard of the values of the second polynomial on the at least part of identifications in the target identification set, where the second party executes the shared polynomial evaluation protocol based on the third polynomial.

According to one or more embodiments of the present disclosure, Example 10 provides a method of data processing for secure computation. The parties involved in the secure computation include a first party and a second party, the first party holds a first identification set, identifications in the first identification set correspond to h-dimensional features, the second party holds a second identification set, and h≥1. The method is applied to the second party and includes: performing a data processing process based on a target protocol with the first party based on the second identification set to obtain at least a first index number of an intersection of the first identification set and the second identification set in the first identification set; generating a target identification set based on the first index number; computing values of each polynomial in at least one first polynomial on at least part of identifications in the target identification set with the first party to obtain a sixth shard of the values, where the at least one first polynomial is constructed by the first party for each individual dimension of at least some dimensions in the h-dimensional features based on an individual dimension corresponding to an identification in a third identification set, the third identification set is generated by the first party based on index numbers of the identifications in the first identification set, and the third identification set and the target identification set are generated in the same manner; and performing a target data processing task based at least on the sixth shard.

According to one or more embodiments of the present disclosure, Example 11 provides the method of Example 10, where the identification in the second identification set corresponds to a single-dimensional feature; and performing the data processing process based on the target protocol with the first party based on the second identification set to obtain at least the first index number of the intersection of the first identification set and the second identification set in the first identification set includes: executing an oblivious pseudo-random function protocol with the first party based on the second identification set and the single-dimensional feature to obtain a third shard of the single-dimensional feature corresponding to the second identification set and a first blind text based on the second identification set; performing an intersection operation on the first blind text and the second blind text to obtain the first index number and a second index number of the intersection in the second identification set in response to receiving the second blind text sent by the first party, where the second blind text is obtained by the first party by blinding hash values of the identifications in the first identification set; and selecting a fourth shard of the single-dimensional feature corresponding to the intersection from the third shard according to the second index number, and sending the second index number to the first party, so that the first party obtains a fifth shard of the single-dimensional feature corresponding to the intersection according to the second index number.

According to one or more embodiments of the present disclosure, Example 12 provides the method of Example 11, where executing the oblivious pseudo-random function protocol with the first party based on the second identification set and the single-dimensional feature to obtain the third shard of the single-dimensional feature corresponding to the second identification set and the first blind text based on the second identification set includes: generating a second blinding factor, and blinding hash values of the identifications in the second identification set with the second blinding factor to obtain a third blind text; performing homomorphic encryption on the single-dimensional feature to obtain the ciphertext feature; sending the ciphertext feature and the third blind text to the first party, so that the first party masks the ciphertext feature to obtain the masked data, and blinds the third blind text to obtain the fourth blind text, and sends the masked data and the fourth blind text to the second party; and performing homomorphic decryption on the received masked data to obtain the third shard, and performing de-blinding on the received fourth blind text with the second blinding factor to obtain the first blind text.

According to one or more embodiments of the present disclosure, Example 13 provides the method of Example 11, where performing the target data processing task based at least on the sixth shard includes: performing the target data processing task based on the sixth shard and the fourth shard.

According to one or more embodiments of the present disclosure, Example 14 provides the method of Example 10, where the identification in the second identification set does not correspond to any feature; and performing the data processing process based on the target protocol with the first party based on the second identification set to obtain at least the first index number of the intersection of the first identification set and the second identification set in the first identification set includes: executing an oblivious pseudo-random function protocol with the first party based on the second identification set to obtain the first blind text based on the second identification set; and performing an intersection operation on the first blind text and the second blind text to obtain the first index number in response to receiving the second blind text sent by the first party, where the second blind text is obtained by the first party by blinding hash values of the identifications in the first identification set.

According to one or more embodiments of the present disclosure, Example 15 provides the method of Example 14, where executing the oblivious pseudo-random function protocol with the first party based on the second identification set to obtain the first blind text based on the second identification set includes: generating a second blinding factor, and blinding hash values of the identifications in the second identification set with the second blinding factor to obtain a third blind text; sending the third blind text to the first party, so that the first party blinds the third blind text to obtain a fourth blind text, and sends the fourth blind text to the second party; and performing de-blinding on the received fourth blind text with the second blinding factor to obtain the first blind text.

According to one or more embodiments of the present disclosure, Example 16 provides the method of Example 10, where computing the values of the first polynomial on the at least part of identifications in the target identification set with the first party to obtain the sixth shard of the values includes: constructing a fourth polynomial based on the target identification set, and performing homomorphic encryption on the fourth polynomial to obtain a ciphertext polynomial; sending the ciphertext polynomial to the first party, so that the first party performs a degree reduction process on the first polynomial corresponding to each individual dimension of the at least some dimensions in the h-dimensional features according to the ciphertext polynomial to obtain a second polynomial; and computing values of the second polynomial on the at least part of identifications in the target identification set with the first party to obtain the sixth shard.

According to one or more embodiments of the present disclosure, Example 17 provides the method of Example 16, where computing the values of the second polynomial on the at least part of identifications in the target identification set with the first party to obtain the sixth shard of the values includes: decrypting the masked polynomial to obtain a third polynomial in response to receiving the masked polynomial sent by the first party, where the masked polynomial is obtained by the first party by masking a random polynomial generated by the first party; and executing a shared polynomial evaluation protocol with the first party based on the third polynomial to obtain the sixth shard of the values of the second polynomial on the at least part of identifications in the target identification set, where the first party executes the shared polynomial evaluation protocol based on the random polynomial.

According to one or more embodiments of the present disclosure, Example 18 provides a computer-readable medium having a computer program stored thereon, where when the program is executed by a processing apparatus, the steps of the method described in any one of Examples 1 to 17 are implemented.

According to one or more embodiments of the present disclosure, Example 19 provides an electronic device, including: a storage apparatus having a computer program stored thereon; and a processing apparatus, configured to execute the computer program in the storage apparatus to implement the steps of the method described in any one of Examples 1 to 17.

According to one or more embodiments of the present disclosure, Example 20 provides a computer program product, including a computer program, where when the computer program is executed by a processor, the steps of the method described in any one of Examples 1 to 17 are implemented.

The preceding descriptions are merely preferred embodiments of the present disclosure and explanations of the applied technical principles. Those skilled in the art should understand that the scope of disclosure involved in the present disclosure is not limited to the technical solutions formed by the specific combination of the preceding technical features, and should also cover other technical solutions formed by any combination of the preceding technical features or equivalent features thereof without departing from the preceding disclosed concept, for example, a technical solution formed by replacing the preceding features with the technical features with similar functions disclosed in the present disclosure (but not limited to).

In addition, although operations are depicted in a particular order, this should not be understood as requiring these operations to be performed in the specific order shown or in a sequential order. Under certain circumstances, multitasking and parallel processing may be advantageous. Likewise, although the preceding discussion contains several specific implementation details, these should not be construed as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or logical actions of methods, it should be understood that the subject matter defined in the appended claims is not necessarily limited to the specific features or actions described above. Rather, the specific features and actions described above are merely example forms of implementing the claims. Regarding the apparatuses in the preceding embodiments, the specific manners in which the respective modules perform operations have been described in detail in the embodiments relating to the method, which will not be described in detail here.

1. A method of data processing for secure computation, wherein parties involved in the secure computation comprise a first party and a second party, the first party holds a first identification set, identifications in the first identification set correspond to h-dimensional features, the second party holds a second identification set, and h≥1, wherein the method is applied to the first party, and comprises:
performing, based on the first identification set, a data processing process based on a target protocol with the second party, such that the second party obtains at least a first index number of an intersection of the first identification set and the second identification set in the first identification set;
obtaining a first polynomial corresponding to each individual dimension of at least some dimensions of the h-dimensional features, wherein the first polynomial is constructed based on the individual dimension corresponding to an identification in a third identification set, and the third identification set is generated based on index numbers of the identifications in the first identification set; and computing, with the second party, values of the first polynomial on at least part of identifications in a target identification set to obtain a first shard of the values, wherein the target identification set is generated by the second party based on the first index number, and the third identification set and the target identification set are generated in the same manner; and
performing a target data processing task based at least on the first shard.

2. The method according to claim 1, wherein the identification in the second identification set corresponds to a single-dimensional feature; and
performing, based on the first identification set, the data processing process based on the target protocol with the second party, such that the second party obtains at least the first index number of the intersection of the first identification set and the second identification set in the first identification set comprises:
executing an oblivious pseudo-random function protocol with the second party to obtain a first blinding factor and a second shard of the single-dimensional feature corresponding to the second identification set, wherein the second party executes the oblivious pseudo-random function protocol based on the second identification set and the single-dimensional feature to obtain a third shard of the single-dimensional feature corresponding to the second identification set and a first blind text based on the second identification set;
blinding hash values of the identifications in the first identification set with the first blinding factor to obtain a second blind text;
sending the second blind text to the second party, such that the second party performs an intersection operation on the first blind text and the second blind text to obtain the first index number, a second index number of the intersection in the second identification set, and a fourth shard of the single-dimensional feature corresponding to the intersection, and sending the second index number to the first party; and
selecting a fifth shard of the single-dimensional feature corresponding to the intersection from the second shard according to the received second index number.

3. The method according to claim 2, wherein executing the oblivious pseudo-random function protocol with the second party to obtain the first blinding factor and the second shard of the single-dimensional feature corresponding to the second identification set comprises:
scrambling an order of a ciphertext feature and an order of a third blind text and generating n random variables and the first blinding factor in response to receiving the ciphertext feature and the third blind text sent by the second party, wherein the ciphertext feature is obtained by the second party by performing homomorphic encryption on the single-dimensional feature, n is a number of the identifications in the second identification set, and the third blind text is obtained by the second party by blinding hash values of the identifications in the second identification set;
masking the scrambled ciphertext feature obtained by scrambling the order of the ciphertext feature with the n random variables to obtain masked data, blinding the scrambled third blind text obtained by scrambling the order of the third blind text with the first blinding factor to obtain a fourth blind text, and sending the masked data and the fourth blind text to the second party, such that the second party performs homomorphic decryption on the masked data to obtain the third shard, and performs de-blinding on the fourth blind text to obtain the first blind text; and
determining the n random variables as the second shard.

4. The method according to claim 2, wherein performing the target data processing task based at least on the first shard comprises:
performing the target data processing task based on the first shard and the fifth shard.

5. The method according to claim 1, wherein the identification in the second identification set does not correspond to any feature; and
performing, based on the first identification set, the data processing process based on the target protocol with the second party, such that the second party obtains at least the first index number of the intersection of the first identification set and the second identification set in the first identification set comprises:
executing an oblivious pseudo-random function protocol with the second party to obtain a first blinding factor, wherein the second party executes the oblivious pseudo-random function protocol based on the second identification set to obtain a first blind text based on the second identification set;
blinding hash values of the identifications in the first identification set with the first blinding factor to obtain a second blind text; and
sending the second blind text to the second party, such that the second party performs an intersection operation on the first blind text and the second blind text to obtain the first index number.

6. The method according to claim 5, wherein executing the oblivious pseudo-random function protocol with the second party to obtain the first blinding factor comprises:
scrambling an order of a third blind text sent by the second party and generating the first blinding factor in response to receiving the third blind text, wherein the third blind text is obtained by the second party by blinding hash values of the identifications in the second identification set; and
blinding the scrambled third blind text obtained by scrambling the order of the third blind text with the first blinding factor to obtain a fourth blind text, and sending the fourth blind text to the second party, such that the second party performs de-blinding on the fourth blind text to obtain the first blind text.

7. The method according to claim 1, wherein obtaining a first polynomial corresponding to the individual dimension comprises:
performing polynomial interpolation on the individual dimension corresponding to the identification in the third identification set by using a fast Fourier transform method to obtain the first polynomial corresponding to the individual dimension.

8. The method according to claim 1, wherein computing the values of the first polynomial on the at least part of identifications in the target identification set with the second party to obtain the first shard of the values comprises:
performing a degree reduction process on the first polynomial according to a ciphertext polynomial sent by the second party to obtain a second polynomial in response to receiving the ciphertext polynomial, wherein the ciphertext polynomial is generated by the second party based on the target identification set; and
computing values of the second polynomial on the at least part of identifications in the target identification set with the second party to obtain the first shard.

9. The method according to claim 8, wherein computing the values of the second polynomial on the at least part of identifications in the target identification set with the second party to obtain the first shard of the values comprises:
generating a random polynomial with the same degree as the second polynomial;
masking the second polynomial with the random polynomial to obtain a masked polynomial, and sending the masked polynomial to the second party, such that the second party decrypts the masked polynomial to obtain a third polynomial; and
executing a shared polynomial evaluation protocol with the second party based on the random polynomial to obtain the first shard of the values of the second polynomial on the at least part of identifications in the target identification set, wherein the second party executes the shared polynomial evaluation protocol based on the third polynomial.

10. A method of data processing for secure computation, wherein parties involved in the secure computation comprise a first party and a second party, the first party holds a first identification set, identifications in the first identification set correspond to h-dimensional features, the second party holds a second identification set, and h≥1, wherein the method is applied to the second party, and comprises:
performing, based on the second identification set, a data processing process based on a target protocol with the first party to obtain at least a first index number of an intersection of the first identification set and the second identification set in the first identification set;
generating a target identification set based on the first index number;
computing, with the first party, values of each polynomial in at least one first polynomial on at least part of identifications in the target identification set to obtain a sixth shard of the values, wherein the at least one first polynomial is constructed by the first party for each individual dimension of at least some dimensions in the h-dimensional features based on the individual dimension corresponding to an identification in a third identification set, the third identification set is generated by the first party based on index numbers of the identifications in the first identification set, and the third identification set and the target identification set are generated in the same manner; and
performing a target data processing task based at least on the sixth shard.

11. The method according to claim 10, wherein the identification in the second identification set corresponds to a single-dimensional feature; and
performing, based on the second identification set, the data processing process based on the target protocol with the first party to obtain at least the first index number of the intersection of the first identification set and the second identification set in the first identification set comprises:
executing an oblivious pseudo-random function protocol with the first party based on the second identification set and the single-dimensional feature to obtain a third shard of the single-dimensional feature corresponding to the second identification set and a first blind text based on the second identification set;
performing an intersection operation on the first blind text and a second blind text sent by the first party to obtain the first index number and a second index number of the intersection in the second identification set in response to receiving the second blind text, wherein the second blind text is obtained by the first party by blinding hash values of the identifications in the first identification set; and
selecting a fourth shard of the single-dimensional feature corresponding to the intersection from the third shard according to the second index number, and sending the second index number to the first party, such that the first party obtains a fifth shard of the single-dimensional feature corresponding to the intersection according to the second index number.

12. The method according to claim 11, wherein executing the oblivious pseudo-random function protocol with the first party based on the second identification set and the single-dimensional feature to obtain the third shard of the single-dimensional feature corresponding to the second identification set and the first blind text based on the second identification set comprises:
generating a second blinding factor, and blinding hash values of identifications in the second identification set with the second blinding factor to obtain a third blind text;
performing homomorphic encryption on the single-dimensional feature to obtain a ciphertext feature;
sending the ciphertext feature and the third blind text to the first party, such that the first party masks the ciphertext feature to obtain masked data, and blinds the third blind text to obtain a fourth blind text, and sending the masked data and the fourth blind text to the second party; and
performing homomorphic decryption on the received masked data to obtain the third shard, and performing de-blinding on the received fourth blind text with the second blinding factor to obtain the first blind text.

13. The method according to claim 11, wherein performing the target data processing task based at least on the sixth shard comprises:
performing the target data processing task based on the sixth shard and the fourth shard.

14. The method according to claim 10, wherein the identification in the second identification set does not correspond to any feature; and
performing, based on the second identification set, the data processing process based on the target protocol with the first party to obtain at least the first index number of the intersection of the first identification set and the second identification set in the first identification set comprises:
executing an oblivious pseudo-random function protocol with the first party based on the second identification set to obtain a first blind text based on the second identification set; and
performing an intersection operation on the first blind text and a second blind text sent by the first party to obtain the first index number in response to receiving the second blind text, wherein the second blind text is obtained by the first party by blinding hash values of the identifications in the first identification set.

15. The method according to claim 14, wherein executing the oblivious pseudo-random function protocol with the first party based on the second identification set to obtain the first blind text based on the second identification set comprises:
generating a second blinding factor, and blinding hash values of the identifications in the second identification set with the second blinding factor to obtain a third blind text;
sending the third blind text to the first party, such that the first party blinds the third blind text to obtain a fourth blind text, and sending the fourth blind text to the second party; and
performing de-blinding on the received fourth blind text with the second blinding factor to obtain the first blind text.

16. The method according to claim 10, wherein computing the values of the first polynomial on the at least part of identifications in the target identification set with the first party to obtain the sixth shard of the values comprises:
constructing a fourth polynomial based on the target identification set, and performing homomorphic encryption on the fourth polynomial to obtain a ciphertext polynomial; and
sending the ciphertext polynomial to the first party, such that the first party performs a degree reduction process on the first polynomial corresponding to each individual dimension of the at least some dimensions in the h-dimensional features according to the ciphertext polynomial to obtain a second polynomial; and computing values of the second polynomial on the at least part of identifications in the target identification set with the first party to obtain the sixth shard.

17. The method according to claim 16, wherein computing the values of the second polynomial on the at least part of identifications in the target identification set with the first party to obtain the sixth shard of the values comprises:
decrypting a masked polynomial sent by the first party to obtain a third polynomial in response to receiving the masked polynomial, wherein the masked polynomial is obtained by the first party by masking a random polynomial generated by the first party; and
executing a shared polynomial evaluation protocol with the first party based on the third polynomial to obtain the sixth shard of the values of the second polynomial on the at least part of identifications in the target identification set, wherein the first party executes the shared polynomial evaluation protocol based on the random polynomial.

18. A non-transitory computer-readable storage medium having a computer program stored thereon, wherein the computer program, upon being executed by a processor, performs a method of data processing for secure computation, wherein parties involved in the secure computation comprise a first party and a second party, the first party holds a first identification set, identifications in the first identification set correspond to h-dimensional features, the second party holds a second identification set, and h≥1, wherein the method is applied to the first party, and comprises:
performing, based on the first identification set, a data processing process based on a target protocol with the second party, such that the second party obtains at least a first index number of an intersection of the first identification set and the second identification set in the first identification set;
obtaining a first polynomial corresponding to each individual dimension of at least some dimensions in the h-dimensional features, wherein the first polynomial is constructed based on the individual dimension corresponding to an identification in a third identification set, and the third identification set is generated based on index numbers of the identifications in the first identification set; and computing, with the second party, values of the first polynomial on at least part of identifications in a target identification set to obtain a first shard of the values, wherein the target identification set is generated by the second party based on the first index number, and the third identification set and the target identification set are generated in the same manner; and
performing a target data processing task based at least on the first shard.

19. A non-transitory computer-readable storage medium having a computer program stored thereon, wherein the computer program, upon being executed by a processor, performs the method according to claim 10.

20. An electronic device, comprising:
at least one processor;
at least one memory, configured to store at least one program,
wherein the at least one program, upon being executed by the at least one processor, causes the at least one processor to implement the method according to claim 1.
